(19) United States
(12) Patent Application Publication
(10) Pub. No.: US 2013/0036858 A1
(43) Pub. Date: Feb. 14, 2013

(54) BICYCLE HANDLEBAR GRIP

(71) Applicant: Yu-Hsin LIN, Taichung City (TW)

(72) Inventor: Yu-Hsin LIN, Taichung City (TW)

(21) Appl. No.: 13/558,639

(22) Filed: Jul. 26, 2012

(30) Foreign Application Priority Data
Aug. 12, 2011 (TW) 100128929

(51) Int. Cl. B62K 21/26

(52) U.S. Cl. 74/551.9

(57) ABSTRACT

A bicycle handlebar grip includes a grip member, an elastic member, a bolt, and a nut. The grip member has a hole at an end and a bore at an opposite end. The elastic member has a hole, which is open at opposite ends thereof, whereby the elastic member expands in a radial direction when the elastic member is compressed in an axial direction. A bolt is inserted into the bore of the grip member and the hole of the elastic member. The nut engages the bolt whereby the bolt and the nut compress the elastic member when the bolt is tightened.

### BACKGROUND OF THE INVENTION

1. Field of the Invention

The present invention relates generally to a bicycle, and more particularly to a bicycle handlebar grip.

2. Description of the Related Art

Nowadays, bicycles are changed from a tool for transportation to a tool for sport. Cycling is not only good for health, but also achieves the purpose of energy conservation and carbon reduction.

A conventional bicycle is provided with a pair of grips to be mounted onto opposite ends of a handlebar. Rider holds the grips to control the bicycle. However, the grips may be loose after a long-term usage or a heavy duty off-road riding that may cause danger in cycling. In order to overcome the loose grip problem, as shown in FIG. 1 and FIG. 2, an improved grip is provided in the market. The grip has a grip member 100 and two rings 200. The ring 200 has a hole 210 at a center and a gap 220. The rings 200 are fitted to opposite ends of the grip member 100, and are fastened by bolts 300 that may firmly fix the grip member 100 to the handlebar by tightening the bolt 300. However, the rings 200 and the bolts 300 are exposed so that the rider may touch the rings 200 and the bolts 300 in cycling, and that may interfere with the rider to operate the bicycle, and furthermore it may hurt rider's hands. In conclusion, there are still some shortness for the conventional handlebar be improved.

### SUMMARY OF THE INVENTION

The primary objective of the present invention is to provide a bicycle handlebar grip, which can be firmly fixed to the handlebar and consequently create a pleasant and safe cycling environment.

According to the objective of the present invention, the present invention provides a bicycle handlebar grip, including a grip member, an elastic member, a bolt, and a nut. The grip member has a hole at an end and a bore at an opposite end. The elastic member has a hole, which is open at opposite ends of the elastic member, whereby the elastic member expands in a radial direction when the elastic member is compressed in an axial direction. A bolt is inserted into the bore of the grip member as well as the hole of the elastic member. The nut engages the bolt whereby the bolt and the nut compress the elastic member when the bolt is tightened.

In an embodiment, the grip member is fitted to an end of a handlebar of a bicycle, and the elastic member is received in the handlebar whereby the elastic member is deformed in the radial direction to press the handlebar when the bolt is tightened to compress the elastic member in the axial direction.

In an embodiment, the elastic member has a recess to receive the nut.

In an embodiment, the grip member has a protrusion at an inner side, and elastic member has a slot to engage the protrusion of the grip member.

In an embodiment, the protrusion is polygonal, and the slot is complemented to the protrusion.

In an embodiment, the elastic member is made of rubber.

In an embodiment, the elastic member is made of flexible plastic.

In an embodiment, the nut has a plate to touch an end of the elastic member.

In an embodiment, the grip further has a board between the elastic member and the nut, wherein the board has a first positioning portion at an end and a second positioning portion at an opposite end; the first positioning portion engages the elastic member; and the second positioning portion engages the nut.

In an embodiment, the board is a bent plate to form a convex portion and a concave portion opposite to the convex portion; the convex portion forms the first positioning portion; and the concave portion forms the second positioning portion.

Therefore, the grip is firmly fixed to the handlebar to provide the rider an easy and safe way to operate the bicycle.

### BRIEF DESCRIPTION OF THE DRAWINGS

FIG. 1 is an exploded view of the conventional handlebar grip;

FIG. 2 is a perspective view of the conventional handlebar grip;

FIG. 3 is an exploded view of a first preferred embodiment of the present invention;

FIG. 4 is a perspective view of the first preferred embodiment of the present invention;

FIG. 5 is a sectional view of the first preferred embodiment of the present invention;

FIG. 6 is another sectional view of the first preferred embodiment of the present invention;

FIG. 7 is an exploded view of a second preferred embodiment of the present invention;

FIG. 8 is a sectional view of the second preferred embodiment of the present invention;

FIG. 9 is another sectional view of the second preferred embodiment of the present invention;

FIG. 10 is an exploded view of a third preferred embodiment of the present invention;

FIG. 11 is a right view of the third preferred embodiment of the present invention;

FIG. 12 is an exploded view of a fourth preferred embodiment of the present invention; and

FIG. 13 is a perspective view of the fourth preferred embodiment of the present invention.

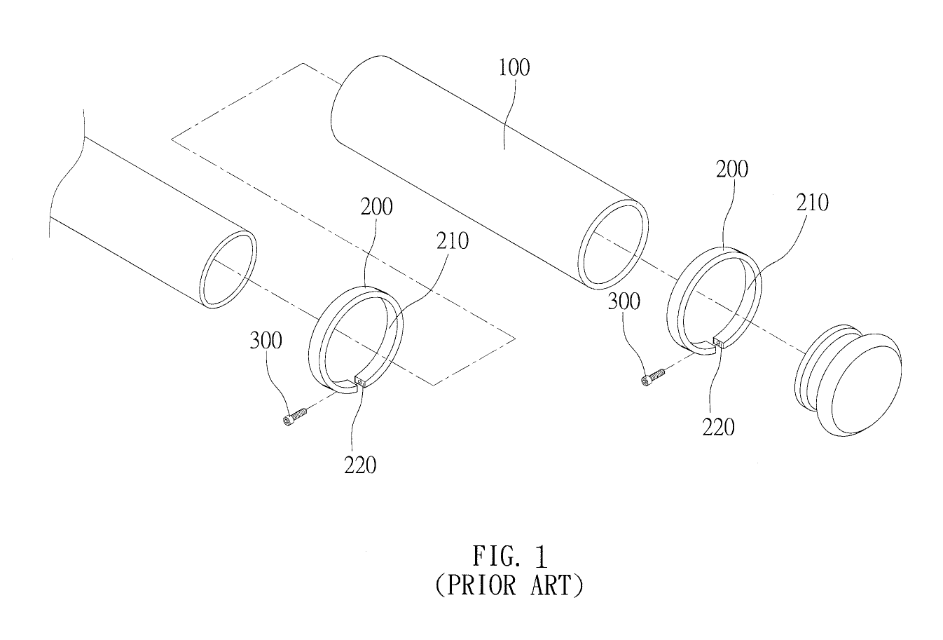

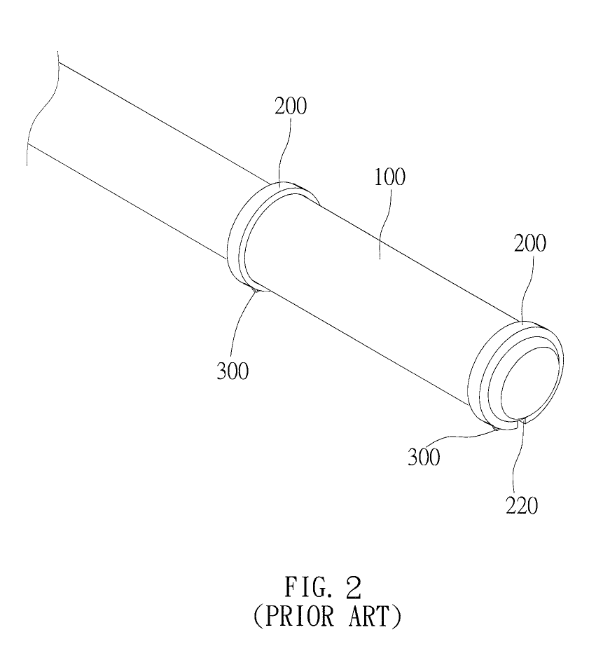

### DETAILED DESCRIPTION OF THE INVENTION

The detailed description and technical contents of the present invention will be explained with reference to the accompanying drawings. However, the drawings are illustrative only, but not used to limit the present invention.

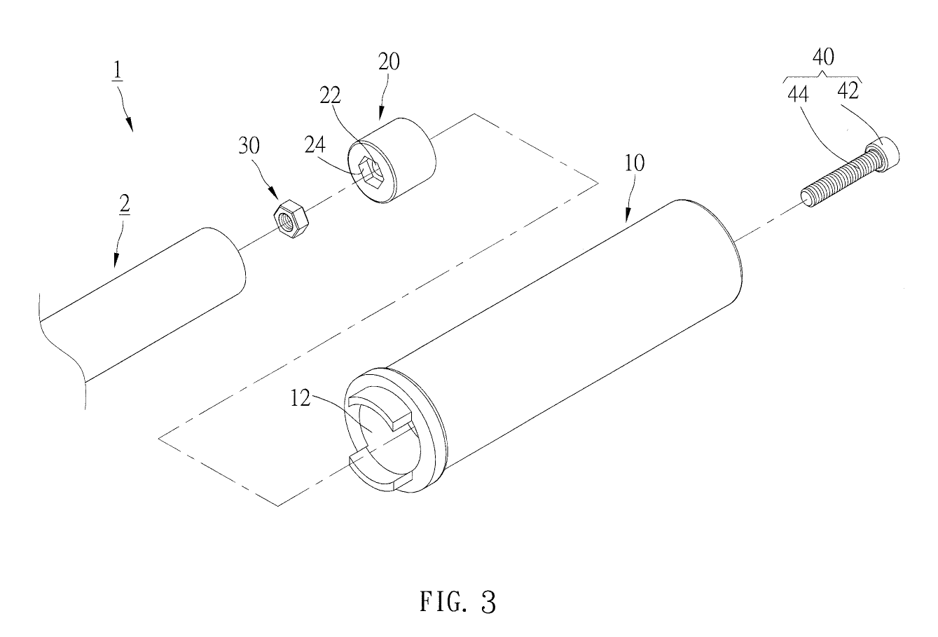

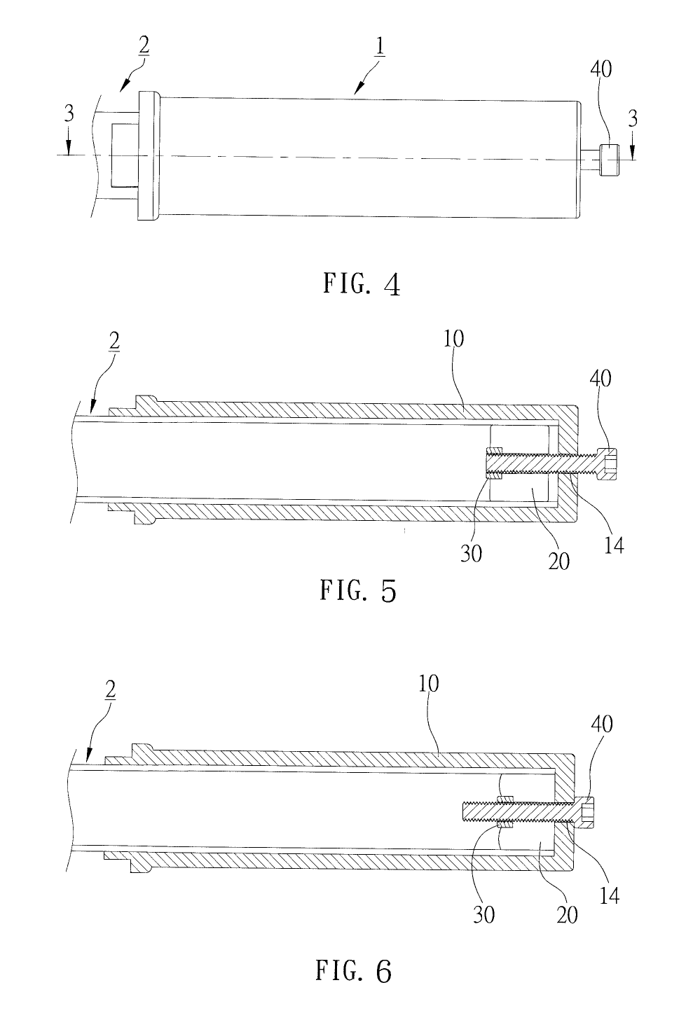

As shown in FIG. 3 to FIG. 6, a grip 1 of the first preferred embodiment of the present invention is mounted on a handlebar 2 of a bicycle. The handlebar 2 is a tubular member. The grip 1 has a grip member 10, an elastic member 20, a nut 30, and a bolt 40.

The grip member 10 is a barrel, having an hole 12 at an end thereof and a bore 14 at the other end. The grip member 10 is fitted to the handlebar 2 via the hole 12, and the bore 14 is communicated with a hole in the handlebar 2.

The elastic member 20 is made of rubber or flexible plastic, and is received in the handlebar 2. The elastic member 20 has a hole 22 at an end and a recess 24 at the other end. The recess 24 is hexagonal and is communicated with the hole 22. The bore 14 of the grip member 10 is aligned with the hole 22 as well as the recess 24. A diameter of the recess 24 is greater than the hole 22. The elastic member 20 expands in a radial direction if the elastic member 20 is compressed in an axis direction.

The nut 30 is hexagonal and is received in the recess 24 of the elastic member 20. In practice, the nut 30 and the recess 24 are a pair of complements, and any non-circle shape, which makes the nut 30 non-rotatable, may be used.

The bolt 40 has a head 42 and a rod 44. The rod 44 is inserted into the bore 14 of the grip member 10 and the hole 22 of the elastic member 20 in sequence to engage the nut 30, as shown in FIG. 5. When one tightens the bolt 40, the head 42 and the nut 30 will come closer to compress the elastic member 20 in the axial direction. At the same time, the elastic member 20 expands in the radial direction to stuff a hole of the handlebar 2 up. Therefore, the elastic member 20 is firmly stuck in the handlebar 2, and the grip member 10 is fixed to the handlebar 2 consequently, as shown in FIG. 6.

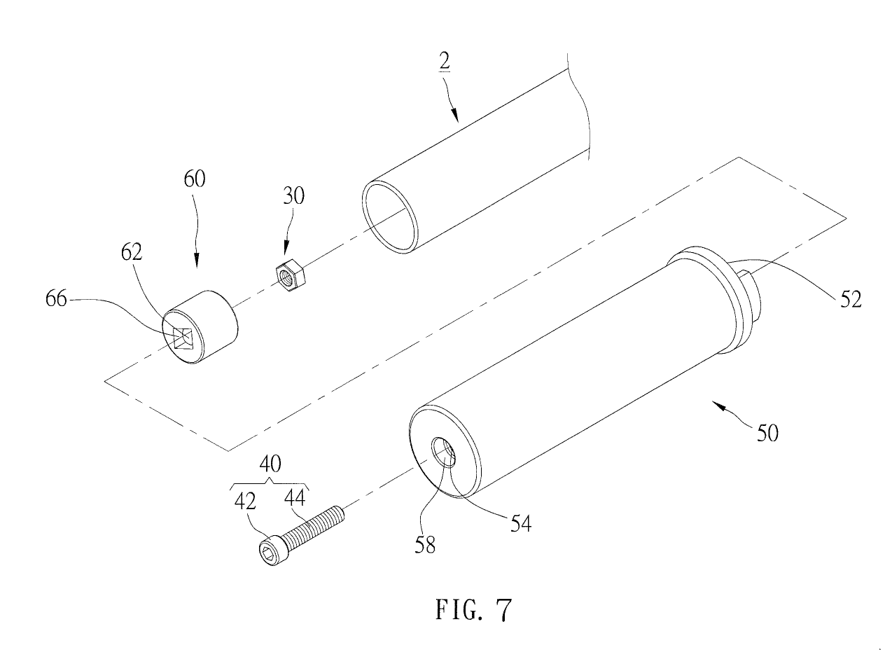

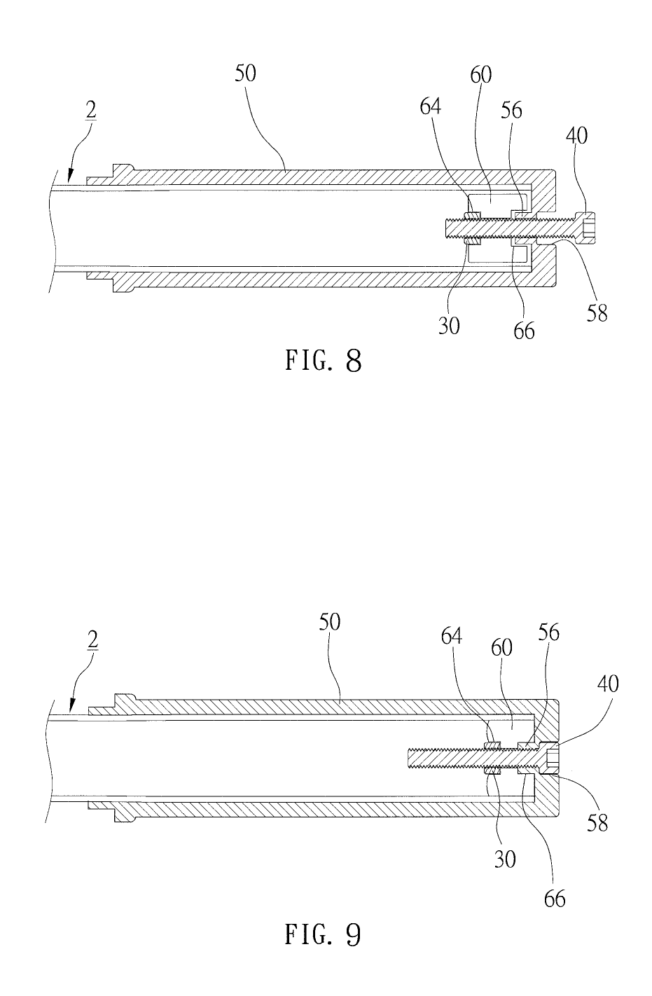

FIG. 7, FIG. 8, and FIG. 9 show a grip of the second preferred embodiment of the present invention, having a grip member 50 and an elastic member 60. The same as above, the grip member 50 has a hole 52 at an end thereof and a bore 54 at the other end, and the elastic member 60 has a hole 62 at an end and a recess 64 at the other end. The grip member 50 further has a rectangular protrusion 56 at an inner side, and the bore 54 passes through the protrusion 56. The grip member 50 further has a recess 58 at an outer side, and the bore 54 is open at a bottom of the recess 58. The elastic member 60 further has a rectangular recess 66 at the end opposite to the recess 64. The elastic member 60 is received in the handlebar 2, and the grip member 50 is fitted to the handlebar 2 to engage the protrusion 56 with the recess 66, so that the elastic member 60 is unable to rotate relative to the grip member 50. The nut 30 is received in the recess 64 of the elastic member 60. The rod 44 of the bolt 40 is inserted into the bore 54 of the grip member 50 and the hole 62 of the elastic member 60 to engage the nut 30, and the head 42 is received in the recess 58 to the grip member 50. The same as above, tightening the bolt 40 may deform the elastic member 60 and fix the grip member 50. It is noted that the protrusion 56 and the recess 66 are a pair of complements, and any non-circle shape, which makes the grip member 50 unable to rotate, may be used.

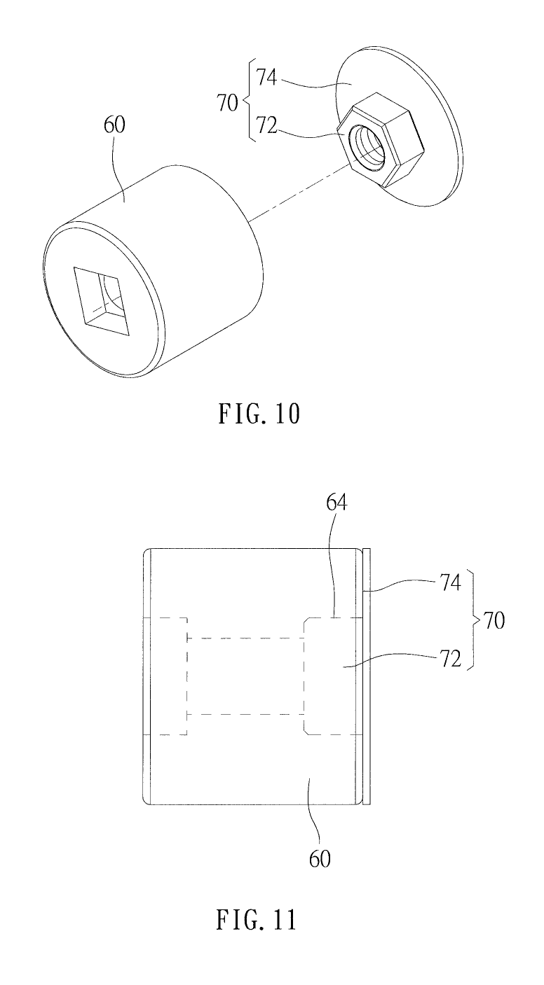

FIG. 10 and FIG. 11 show a grip of the third preferred embodiment of the present invention, which is almost the same as above embodiments, except a nut 70. The elastic member 60 is the same as the second embodiment. The nut 70 has a main body 72 and a plate 74 at an end of the main body 72. The plate 74 has the same size and shape of the elastic member 60 to be attached to the end of the elastic member 60 when the main body 72 is received in the recess 64. The plate 74 will compress the entire end of the elastic member 60 to make a greater expansion of the elastic member 60 in the radial direction when one tightens the bolt 40, so that the elastic member 60 will be more firmly struck in the handlebar 2.

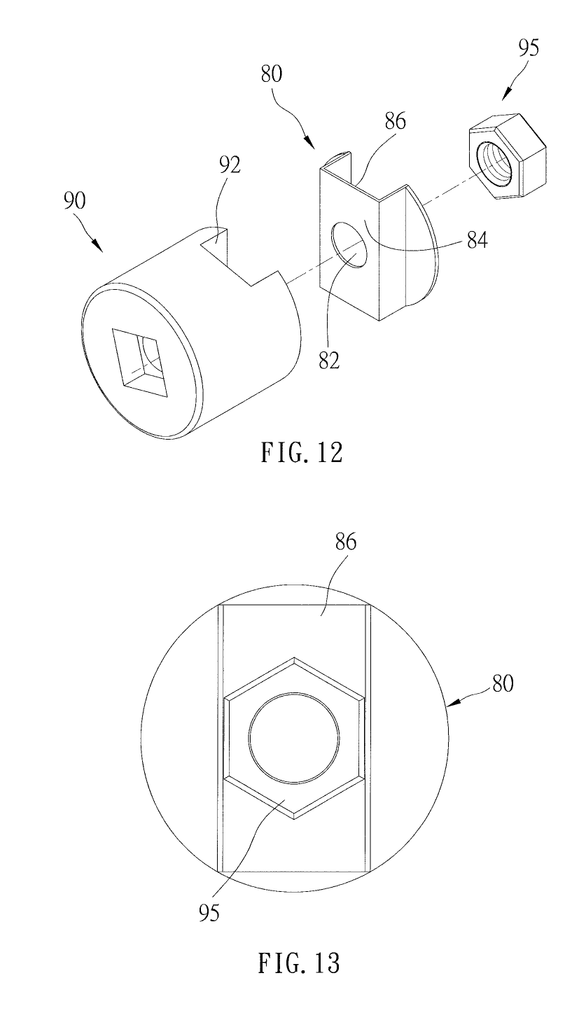

FIG. 12 and FIG. 13 show a grip of the fourth preferred embodiment of the present invention, in which a board 80 is provided. The board 80 is placed between an elastic member 90 and a nut 95. The board 80 has an opening 82 at a center. The board 80 is bent into U-shape, and the opening 82 is at the middle of the U-shape. The convex portion of the board 80 forms a first positioning portion 84, and the concave portion forms a second positioning portion 86. The first positioning portion 84 engages a slot 92 of the elastic member 90, and the second positioning portion 86 engages the nut 95. A width of the second positioning portion 86 is slightly greater than a distance between two parallel sides of the nut 95 so that the nut 95 is received in the second positioning portion 86 and is unable to rotate. The board 80 has the same function of the plate 74 of the third embodiment.

After the grip of the present invention is mounted on the handlebar of a bike, the turning of the bolt may deform the elastic member and fasten the grip member. There is no component on the grip member so that the riders may hold the grip of the present invention to operate the bike in an easy and safe way.

The description above is a few preferred embodiments of the present invention, and the equivalence of the present invention is still in the scope of claim construction of the present invention.

What is claimed is:

1. A bicycle handlebar grip, comprising:
a grip member having a hole at an end and a bore at an opposite end;
an elastic member having a hole, which is open at opposite ends of the elastic member, whereby the elastic member expands in a radial direction when the elastic member is compressed in an axial direction;
a bolt inserted into the bore of the grip member and the hole of the elastic member; and
a nut engaging the bolt whereby the bolt and the nut compress the elastic member when the bolt is tightened.

2. The bicycle handlebar grip as defined in claim 1, wherein the grip member is fitted to an end of a handlebar of a bicycle, and the elastic member is received in the handlebar whereby the elastic member is deformed in the radial direction to press the handlebar when the bolt is tightened to compress the elastic member in the axial direction.

3. The bicycle handlebar grip as defined in claim 1, wherein the elastic member has a recess to receive the nut.

4. The bicycle handlebar grip as defined in claim 1, wherein the grip member has a protrusion at an inner side, and elastic member has a slot to engage the protrusion of the grip member.

5. The bicycle handlebar grip as defined in claim 4, wherein the protrusion is polygonal, and the slot is complemented to the protrusion.

6. The bicycle handlebar grip as defined in claim 1, wherein the elastic member is made of rubber.

7. The bicycle handlebar grip as defined in claim 1, wherein the elastic member is made of flexible plastic.

8. The bicycle handlebar grip as defined in claim 1, wherein the nut has a plate to touch an end of the elastic member.

9. The bicycle handlebar grip as defined in claim 1, further comprising a board between the elastic member and the nut, wherein the board has a first positioning portion at an end and a second positioning portion at an opposite end;
the first positioning portion engages the elastic member; and the second positioning portion engages the nut.

10. The bicycle handlebar grip as defined in claim 9, wherein the board is a bent plate formed with a convex portion and a concave portion opposite to the convex portion; the convex portion forms the first positioning portion; and the concave portion forms the second positioning portion.
